(19) United States
(12) Patent Application Publication
(10) Pub. No.: US 2026/0227309 A1
(43) Pub. Date: Aug. 6, 2026

(54) PHYSICAL SIMULATION SYSTEM AND METHOD OF POROUS MEDIUM GROUTING WITH TEMPERATURE EFFECT CONSIDERATION

(71) Applicant: SHANDONG UNIVERSITY, Jinan, Shandong (CN)

(72) Inventors: Zhenhao XU, Jinan (CN); Dongdong PAN, Jinan (CN); Shengzhe ZHAO, Jinan (CN); Zehua BU, Jinan (CN); Xiansong WEI, Jinan (CN); Yichi ZHANG, Jinan (CN); Mengyu YANG, Jinan (CN); Shuaifei GE, Jinan (CN)

(73) Assignee: SHANDONG UNIVERSITY, Jinan, Shandong (CN)

(21) Appl. No.: 19/149,492

(22) PCT Filed: Dec. 10, 2024
(86) PCT No.: PCT/CN2024/138229

§ 371 Date: Jul. 18, 2025

(30) Foreign Application Priority Data
Dec. 11, 2023 (CN) 202311705174.3

(51) Int. Cl. G01N 15/08

(52) U.S. Cl. CPC G01N 15/0826; G01N 15/088

(57) ABSTRACT

A physical simulation system and method of porous medium grouting with temperature effect consideration, including: a porous medium formation simulation model, a grouting system, a water level regulation system, a formation temperature control system, and a data analysis system. The porous medium formation simulation model is configured to simulate a porous medium formation. The water level regulation system and the formation temperature control system are configured to simulate cases of different water containing levels and different water temperatures and ground temperatures. The data analysis system is configured to perform verification and analysis on a grouting diffusion path by comparing data collected by sensors such as temperature and pressure sensors at different time series with data such as temperature and pressure data which are obtained through coupled solutions of a heat transfer equation and a Momentum Equation.

### CROSS-REFERENCE TO RELATED APPLICATIONS

The present invention claims priority to Chinese Patent Application No. 202311705174.3, entitled “PHYSICAL SIMULATION SYSTEM AND METHOD OF POROUS MEDIUM GROUTING WITH TEMPERATURE EFFECT CONSIDERATION”, and filed on Dec. 11, 2023, with the China National Intellectual Property Administration, the entire content of which is incorporated herein by reference.

### TECHNICAL FIELD

The present invention belongs to the technical field related to porous medium grouting experiments, and in particular, to a physical simulation system and method of porous medium grouting with temperature effect consideration.

### BACKGROUND

The description in this section merely provides background art information related to the present invention and does not necessarily constitute the prior art.

Water ingress represents a prevalent and critical challenge during tunnel construction, adversely impacting construction quality, causing schedule delays, increasing costs, and potentially triggering severe engineering accidents. Grouting has emerged as the most widely adopted solution for water ingress control. Through phase transition from liquid to solid state over time, grouts effectively block water-bearing channels and reinforce formations, playing a pivotal role in tunnel engineering.

Geological environments vary significantly across regions, and for surge water ingress control under different geological formation conditions, customized grouting designs is required according to the characteristics of the geological formations. The lost-circulation formations filled with porous media such as the sandy gravel are commonly found in alluvial fan plains like the Chengdu Plain and the Small Plain of Beijing. These porous medium formations exhibit unstable mechanical properties, and grout leakage happen easily during grouting reinforcement operations. This typically leads to a substantial increase in grout consumption without effectively stabilizing the formations. Currently, there are no satisfactory solutions for this issue, with common countermeasures limited to increasing the number of boreholes, applying more grout, or using fast-curing grout to meet requirements as much as possible. In local regions where the porous medium formations are affected by high-temperature hot springs and a high ground temperature, conventional grout materials tend to fail during grouting under such environments. The presence of high-temperature water further complicates water ingress control. Therefore, it is crucial to investigate the blockage and diffusion mechanisms of grout in such porous medium environments. Current model experiments carried out for grouting in porous media have not yet been able to fully account for the coupled effects of multiple factors, such as the water containing level and water temperature and ground temperature effects of the porous formations on the grout diffusion mechanism. Furthermore, these experiments fail to achieve precise visualization of the grout diffusion process of grouting in the porous medium formations. In terms of performing the model experiment, an existing grouting device also fails to satisfy the requirements for controllable constant-speed grouting, and convenient grout storing and cleaning.

### SUMMARY

To overcome the above shortcomings in the prior art, the present invention provides a physical simulation system and method of porous medium grouting with water-ground thermal effect consideration, implementing free simulation of different water containing levels and different water temperatures by a water level regulation system, and implementing simulation of different ground temperatures by a formation temperature control system, thereby implementing research on grouting diffusion at different water levels, water temperatures, and ground temperatures.

To achieve the above objective, a first aspect of the present invention provides a physical simulation system of porous medium grouting with temperature effect consideration, including: a porous medium formation simulation model, a grouting system, a water level regulation system, a formation temperature control system, a data collection system and a data analysis system, wherein:
the porous medium formation simulation model includes an experiment box, and the experiment box is filled with a porous medium;
the grouting system is in pipeline communication with a grout inlet of the porous medium formation simulation model to provide a grouting manner with controllable grouting rate and grouting pressure for the porous medium formation simulation model;
the water level regulation system is in pipeline communication with the porous medium formation simulation model to provide a water injection manner with an adjustable water supply amount and a controllable water temperature for the porous medium formation simulation model;
the formation temperature control system includes a heating device and a temperature monitoring sensor, the temperature monitoring sensor is arranged in the porous medium formation simulation model, and the heating device is configured to heat an interior of the porous medium formation simulation model to simulate different ground temperatures;
the data collection system includes a plurality of temperature sensors and pressure sensors, and the temperature sensors and the pressure sensors are respectively distributed at different positions in the porous medium formation simulation model; and
the data analysis system is in signal connection with the data collection system, and configured to perform verification and analysis on a grouting diffusion path by comparing data collected by the temperature sensor and the pressure sensor at different time series with temperature data and pressure data which are obtained through coupled solutions of a heat transfer equation and a Momentum Equation.

A second aspect of the present invention provides an experimental method of porous medium grouting with temperature effect consideration, including:
injecting water with a preset water containing level and a preset water temperature to a porous medium formation simulation model by a water level regulation system, where the porous medium formation simulation model is filled with a porous medium;
heating an interior of the porous medium formation simulation model to a preset ground temperature by a formation temperature control system;
performing, by a grouting system, grouting to the porous medium formation simulation model from a grout inlet formed below the porous medium formation simulation model;
collecting, by a data collection system, temperature data and pressure data in a grouting process, and transmitting the same to a data analysis system; and
performing, by the data analysis system, verification and analysis on a grouting diffusion path by comparing the temperature data and the pressure data which are collected by temperature sensors and pressure sensors at different time series with temperature data and pressure data which are obtained through coupled solutions of a heat transfer equation and a Momentum Equation.

The above one or more technical solutions have the following beneficial effects.

In the present invention, free simulation of different water containing levels is implemented by the water level regulation system, and simulation of different ground temperatures is implemented by the formation water bath temperature control system, thereby implementing research on grouting diffusion at different water levels, water temperatures, and ground temperatures.

In the present invention, the heat transfer equation is introduced to be coupled to the Momentum Equation to simulate the grouting temperature, a grout speed, and a grout diffusion form, and according to comparison between simulated data and experiment-measured data and analysis on a slice of a stone body, precise evolution of a grout diffusion path in a porous formation is implemented.

In the present invention, rapid grout storing and cleaning and constant-speed grouting are implemented by using a screw to connect a piston in cooperation with a speed control module and a gas pressure regulation module. Compared with a conventional constant-speed grouting manner driven by a gas pressure, accurate constant-speed grout injection can be performed in the whole process, and the grout storing and cleaning processes can be convenient.

The advantages of additional aspects of the present invention will be set forth in part in the description below, parts of which will become apparent from the description below, or will be understood from the practice of the present invention.

### BRIEF DESCRIPTION OF THE DRAWINGS

The drawings constituting a part of the present invention are used to provide a further understanding of the present invention. The exemplary examples of the present invention and descriptions thereof are used to explain the present invention, and do not constitute an improper limitation of the present invention.

FIG. 1 is a diagram of an experimental device of porous medium grouting with temperature effect consideration in Example 1 of the present invention;

FIG. 2 is a layout diagram of an experimental model of porous medium grouting with temperature effect consideration in Example 1 of the present invention;

FIG. 3 is a structural diagram of an elevator of a grouting system of the experimental device of porous medium grouting with temperature effect consideration in Example 1 of the present invention; and

FIG. 4 is a flowchart of an experimental method of porous medium grouting with temperature effect consideration in Example 2 of the present invention.

In the figures: 1, porous medium formation simulation system; 2, two-shot grouting system; 3, grout storing tank; 4, waste liquid outflow pipeline; 5, waste liquid collection container; 6, heating device; 7, upper baffle; 8, waste liquid discharging pipeline; 9, cobblestone cushion layer; 10, pressure sensor; 11, osmotic pressure sensor; 12, rubber cushion layer; 13, motor; 14, speed regulation valve; 15, first gas pressure valve 16, gas pressure regulation channel at a screw platform; 17, screw platform; 18, second gas pressure valve; 19, screw; 20, gas pressure regulation channel at a piston; and, 21, piston.

### DETAILED DESCRIPTION

It should be noted that, the following detailed descriptions are all exemplary, and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention.

The examples in the present invention and features in the examples may be mutually combined in case that no conflict occurs.

### Example 1

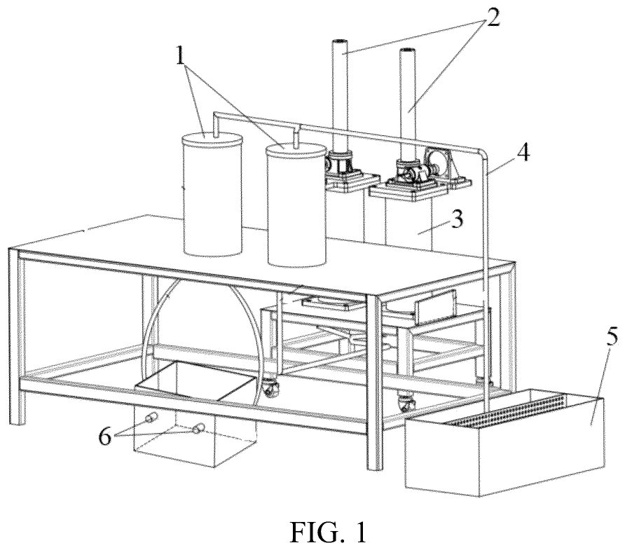

As shown in FIG. 1, the present example discloses a physical simulation system of porous medium grouting with temperature effect consideration, including: a porous medium formation simulation model, a grouting system, a water level regulation system, a formation temperature control system, a data collection system, and a data analysis system.

The porous medium formation simulation model includes an experiment box, and the experiment box is filled with a porous medium.

The grouting system is in pipeline communication with a grout inlet of the porous medium formation simulation model to provide a grouting manner with controllable grouting rate and grouting pressure for the porous medium formation simulation model.

The water level regulation system is in pipeline communication with the porous medium formation simulation model to provide a water injection manner with an adjustable water supply amount and a controllable water temperature for the porous medium formation simulation model.

The formation temperature control system includes a heating device and a temperature in monitoring sensor, the temperature monitoring sensor is arranged in the porous medium formation simulation model, and the heating device is configured to heat an interior of the porous medium formation simulation model to simulate different ground temperatures.

The data collection system includes a plurality of temperature sensors and pressure sensors, and the temperature sensors and the pressure sensors are respectively distributed at different positions in the porous medium formation simulation model.

The data analysis system is in signal connection with the data collection system, and configured to perform verification and analysis on a grouting diffusion path by comparing data collected by the temperature sensor and the pressure sensor at different time series with temperature data and pressure data which are obtained through coupled solutions of a heat transfer equation and a Momentum Equation.

The following describes in detail, with reference to FIG. 1, the physical simulation system of porous medium grouting with temperature effect consideration in the present example.

The physical simulation system of porous medium grouting with temperature effect consideration in the present example includes an experiment platform, a porous medium formation simulation system 1, a two-shot grouting system 2, a water level regulation system, a formation temperature control system, a waste liquid treatment system, a data collection system, a data analysis system, and a visualization system.

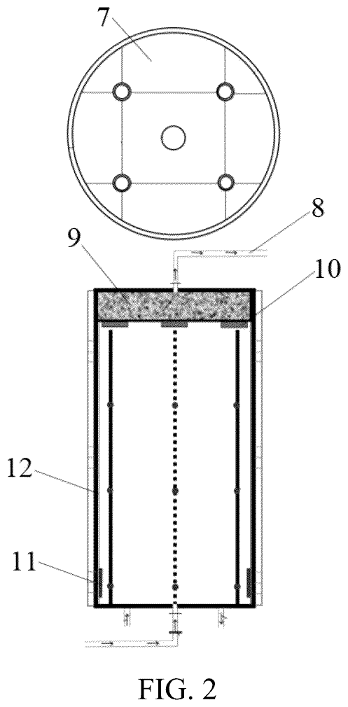

Specifically, as shown in FIG. 2, the porous medium formation simulation system 1 includes an experiment box/barrel and a porous medium to provide an environment and a medium fillable basis for a grouting experiment. Upper and lower portions of the experiment box/barrel are an upper baffle 7 and a lower bottom plate, respectively. A grout-permeable partition plate is arranged at an upper position in the experiment box/barrel. A grout outlet is located at a middle position of the upper baffle 7. A space between the grout-permeable partition plate and the upper baffle 7 is filled with a cobblestone cushion layer 9. The function of the cobblestone cushion layer 9 is to prevent diffusion of grout from driving a medium to flow out of the outlet in a grouting process, and ensure an outflow channel of the grout to avoid an excessive internal pressure. The upper baffle 7 is provided the grout outlet in the middle, and a position of the grout outlet may be adjusted according to actual needs. Sensor containing holes and an inner sensor line outgoing hole are formed around the grout outlet. A grouting hole and a water injection port are formed in a middle of the lower bottom plate, and the water injection port implements regulation of a water level according to a water containing level; and an inner wall of the experiment box/barrel is provided with a rubber cushion layer 12, thereby facilitating demolding after grouting is completed.

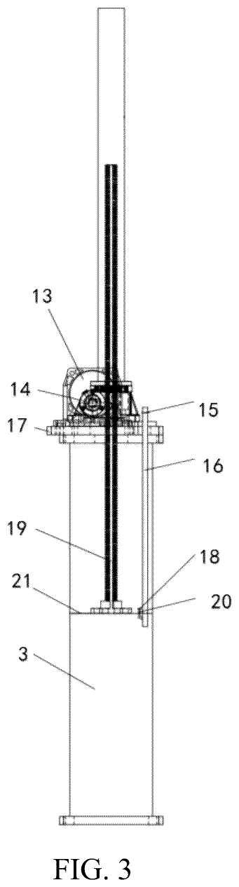

As shown in FIG. 3, the two-shot grouting system 2 includes a grouting module and a control module. The grouting module includes a screw 19, a piston 21, a speed regulation valve 14, a motor 13, a gas pressure regulation module, and a grout storing tank 3. An upper part of the screw 19 penetrates through a screw platform 17, a lower end of the screw 19 is connected to the piston 21, and the screw 19 is located at an inner center of the device and extends into the grout storing tank 3. Driven by the motor 13 and the speed regulation valve 14, the screw 19 applies a steady pressure to the grout in the grout storing tank 3 to implement constant-speed grout discharge, and the piston 21 needs to ensure good gas tightness. The speed regulation valve 14 is arranged on the screw platform 17, and configured to regulate an ascending/descending rate of the screw 19. The motor 13 is connected to the speed regulation valve 14 to provide stable power for running of the grouting system.

The gas pressure regulation module is arranged on an opening of the piston 21 and an opening of the screw platform 17 to implement gas pressure regulation in the grouting process and a grout storing process, which may be used as a grout storing channel and a cleaning channel after the grouting is completed. Specifically, a first opening of the piston 21 is connected to the opening of the screw platform 17 by a pipeline to form a gas pressure regulation channel 16 at the screw platform. A gas pressure regulation channel 20 at the piston is formed at a second opening of the piston 21. A first gas pressure valve 15 is arranged on the gas pressure regulation channel 16 at the screw platform, and a second gas pressure valve 18 is arranged on the gas pressure regulation channel 20 at the piston. When the grout is being stored, the two gas pressure valves are opened to fill the grout from the top. After the injected grout reaches a specified position and is stable, grout storing is completed. During grouting, the two gas pressure valves are closed to implement a sealed environment of the grouting process. The motor 13 drives the piston 21 to push the grout in the grout storing tank 3 to complete the grouting, and the speed regulation valve is used in cooperation to satisfy different grouting speed requirements, thereby implementing sealing in the grouting process to smoothly implement the grouting. The grout storing tank 3 is located below the screw platform 17, fixed to the screw platform 17, and configured to store the grout. After the grouting is completed, the gas pressure regulation module is opened, and high-pressure water is injected through an opening to implement convenient cleaning in the grout storing tank. The control module is configured to implement start/stop of various functions of the grouting module and gear adjustment, thereby finally implementing accurate grouting in a whole experiment process.

The water level regulation system includes a water injection module and a water level control module. The water injection module includes a water tank, a water passage pipeline, a water pump, a water injection port valve, and a water level sensor. The water injection port of the experiment box/barrel in the porous medium formation simulation system is connected to the water tank by the water passage pipeline. The water pump in the water tank injects water into the porous medium formation simulation system 1. The water level control module includes water level sensors, a water level control device, and a water injection start and stop valve. The water level sensors are arranged around the experiment box/barrel to sense a water level change and transmit water level information into the water level control device, thereby implementing real-time injection and stop of water by the water injection port valve.

The formation temperature control system includes a heating device 6, a temperature monitoring device, and a temperature control device. The heating device 6 may use a manner of circulating water bath temperature control outside a model. An inlet of the circulating water heating device is connected to a constant temperature water tank, and an outlet thereof is connected to a pipeline. The pipeline is connected to a heating water tank. A position at which the heating water tank heats water to rise the water temperature is close to the constant temperature water tank to prevent a temperature loss of the water in a process of flowing in the pipeline. After the water is heated to have a set temperature, the water is injected into the constant temperature water tank to keep the water temperature constant. The above steps are repeated to implement water bath temperature control to achieve temperature control of the porous medium. Temperature data is recorded in real time by an internal temperature monitoring sensor. After a specified temperature is reached, under an instruct of the temperature control device, the current temperature is maintained.

The waste liquid treatment system includes a waste liquid outflow pipeline 4 and a waste liquid collection container 5. The waste liquid collection container 5 may implement ordered separation of water and grout. After waste liquid in the experiment box/barrel flows into the waste liquid collection container 5 through a waste liquid discharging pipeline 8 and the waste liquid outflow pipeline 4, grout-water solid-liquid separation is implemented by a filter plate in the waste liquid collection container 5.

The data collection system includes temperature sensors and pressure sensors 10. The temperature sensors are distributed in the porous medium and function to monitor the temperature to ensure that the temperature in the model satisfies a preset temperature, and transmit real-time temperature data to the data analysis system. The pressure sensors 10 are divided into earth pressure sensors and osmotic pressure sensors 11. The earth pressure sensors are distributed around the interior of the model and on the grout-permeable partition plate, and configured to monitor a pressure change in the model. The osmotic pressure sensors 11 are embedded in the porous medium, and configured to monitor the pressure of pore water inside the medium in real time, and transmit real-time data to the data analysis system to obtain a change law of an internal pressure in the grouting process.

The data analysis system includes a thermal analysis module and a pressure analysis module. Based on parameters such as thermal conductivity of an underground medium, a thermal diffusion coefficient, initial boundary conditions, and a temperature at which the grout is injected, the thermal analysis module obtains a temperature and a grouting speed through coupled solutions of a heat transfer equation and an energy equation and compares the temperature and the grouting speed with temperature and pressure time series change data and the like captured by the temperature and pressure sensors to implement verification and analysis of a diffusion path. The pressure analysis module may analyze the pressure of the grout in the medium, analyze a change law of an internal confining pressure and an osmotic pressure of the medium, and obtain a pressure range applicable to grouting blockage of the porous medium under influences of the temperature effect and the water containing level.

The visualization system includes a grout diffusion visualization module, a temperature field visual displaying module, and a pressure field visual displaying module. The grout diffusion visualization module implements dynamic display of the grout diffusion path, and dynamic display of a temperature field and a pressure field.

### Example 2

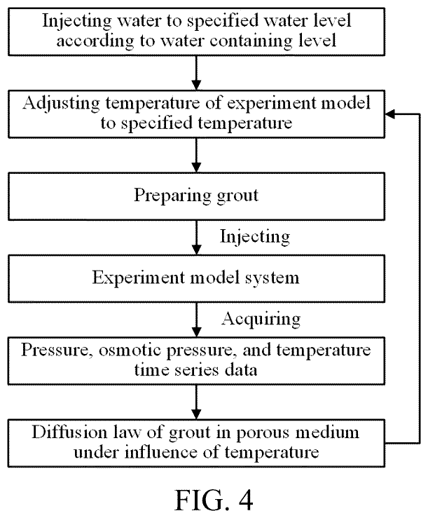

As shown in FIG. 4, the present example provides an experimental method of porous medium grouting with temperature effect consideration, including:
injecting water with a preset water containing level and a preset water temperature to a porous medium formation simulation model by a water level regulation system, where the porous medium formation simulation model is filled with a porous medium;
heating an interior of the porous medium formation simulation model to a preset ground temperature by a formation temperature control system;
performing, by a grouting system, grouting to the porous medium formation simulation model from a grout inlet formed below the porous medium formation simulation model;
collecting, by a data collection system, temperature data and pressure data in a grouting process, and transmitting the same to a data analysis system; and
performing, by the data analysis system, verification and analysis on a grouting diffusion path by comparing the temperature data and the pressure data which are collected by temperature sensors and pressure sensors at different time series with temperature data and pressure data which are obtained through coupled solutions of a heat transfer equation and a Momentum Equation.

Specifically, the experiment method includes the following steps:
Step 1: Water is injected until a water level reaches a specified position according to a water containing level of a formation required for performing an experiment, where a water level control device is provided, thereby ensuring stability of the water level, and implementing automatic regulation of the water level.
Step 2: An experiment model is heated until a temperature in the experiment model reaches a specified temperature, and the temperature is kept constant; to ensure a visual effect of an internal grouting process and a constant temperature control effect, a manner of circulating water bath temperature control outside the model is used, where an inlet of a circulating water heating device is connected to a constant temperature water tank, an outlet thereof is connected to a pipeline, the pipeline is connected to a heating water tank, the heating water tank is close to the constant temperature water tank to prevent a temperature loss of the water in a process of flowing in the pipeline; after the water is heated to an original set temperature, the water is injected into the constant temperature water tank to keep the water temperature constant; and the above steps are repeated to implement water bath temperature control.
Step 3: After the temperature is constant, a single grouting liquid or double grouting liquids are prepared according to experimental requirements and a material ratio, where cement grout, or a specified material such as sodium silicate and a new material may be selected as a material according to the requirements.
Step 4: The prepared grout is injected into the grouting system, a gas pressure control valve and a grouting inlet valve of a grout storing tank of the grouting system are opened to inject the grout into the grout storing tank from an upper end of a grouting channel in a screw, the grouting inlet valve and the gas pressure control valve are closed after the injected grout reaches a specified position, and the water glass or the new material or the like is injected into another set of grouting system in the same way.
Step 5: A speed of a two-shot grouting system is regulated, a switch is turned on to inject the double liquids or the single liquid into the porous medium model, pressure monitoring data in real time in an injection process is tracked and recorded, and pressures of a grout inlet and a side wall of the model are recorded to avoid danger caused by an excessive pressure inside the medium model.
Step 6: A fluid domain grid is constructed according to an experiment model, and the initial boundary conditions are set, where the initial boundary conditions include a grouting speed, a grouting pressure, a grout temperature, and grout viscosity; and a Momentum Equation is constructed according to the grouting speed, the grouting pressure, a phase fraction, and the grout viscosity, and predicting the grouting speed by solving momentum.

The Momentum Equation is:

$$\frac{\partial ( ρ v )}{\partial t} + ∇ \cdot ( ρ vv ) = - ∇ p + ∇ \cdot ( μ ∇ v ) + ρ g + {F}_{s t}$$

Where, ρ is density, p is a pressure, μ represents a viscosity function dependent on time t and the grout temperature T, which may be obtained through experiments, g is a gravitational acceleration, and Fₛₜ is a surface tension.

The grouting speed is obtained by solving a discrete Momentum Equation:

$$\frac{{ρ}^{n + 1} {v}^{n + 1} - {ρ}^{n} {v}^{n}}{Δ t} \cdot {V}_{C V} + {\sum }_{faces} {( ρ v v )}^{n} \cdot {S}_{face} = - {\sum }_{faces} {p}^{n} {S}_{face} + {\sum }_{faces} {( μ ∇ v )}^{n} \cdot {S}_{face} + {ρ}^{n} g \cdot {V}_{C V} + {F}_{s t}^{n} \cdot {V}_{C V}$$

Where, pⁿ⁺¹vⁿ⁺¹ and pⁿvⁿ are a product of the density and the speed at a new time step and an old time step, respectively, V_{CV} is a volume of a control volume, S_{face} is an area vector of a control volume face, pⁿ is a pressure at a current time step, (μΛv)ⁿ is a viscous stress at the current time step, g is the gravitational acceleration,

$${F}_{s t}^{n}$$

is the surface tension, and Δt is a time step size.

Further, a grout-water continuity equation is:

$$( ∇ \cdot v = 0 )$$

Where, v is a fluid speed vector.

A discrete continuity equation is coupled to the Momentum Equation to iteratively solve for the grout pressure and the grouting speed, and after a predetermined iteration count is reached, the grouting pressure and grouting speed are obtained as a grouting pressure and grouting speed v for the current time step.

Further, according to the grouting speed v at the current time step, a grout-water heat transfer equation is constructed:

$$ρ {c}_{p} \frac{\partial T}{\partial t} + ρ {c}_{p} v \cdot ∇ T = ∇ \cdot ( k ∇ T ) + Q \\ Q = - Δ {H}_{rxn} r$$

Where, T is a temperature, cₚ is a specific heat capacity of a fluid, k is thermal conductivity of the porous medium, Q represents a quantity of heat generated and released in a phase change process in which grout is cured, ΔHᵣₓₙ is an empirical value which may be used for a quantity of heat released by per mole of a reaction, r is an empirical value which may be used for a rate of a chemical reaction, and v is the fluid speed vector.

The grout temperature is obtained by solving a discrete prediction equation:

$$\frac{ρ {c}_{p} ( {T}_{n e w} - {T}_{o l d} )}{Δ t} \cdot {V}_{C V} + {\sum }_{faces} ρ {c}_{p} vT \cdot {S}_{face} = {\sum }_{faces} k ∇ T \cdot {S}_{face}$$

Where, T_{new} and T_{old} are a temperature at the new time step and the old time step, respectively, Δt is the time step size, V_{CV} is the volume of the control volume, S_{face} is the area vector of the control volume face, and a direction is perpendicular to the face and points to an outside.

A discrete heat transfer equation is coupled to the Momentum Equation to iteratively solve for the grout temperature and the grouting speed, and after the quantity of the iterations is reached, the grout temperature and grouting speed v are obtained.

According to the grouting speed v at the current time step, a discrete grout-water two-phase phase fraction equation is constructed, a grout diffusion form in the porous medium is obtained by solving the phase fraction equation, and the grout-water two-phase phase fraction equation is:

$$( \frac{\partial α}{\partial t} + ∇ \cdot ( α v ) = 0 )$$

Where, α is a volume proportion occupied by a particular phase in a specified volume.

According to repeated iteration of the above equation, finally, visual presentation of the grout diffusion path is implemented by the phase fraction equation.

Upon simulation, temperature field data and grouting pressure data at the current time step are compared with experiment-measured data, if the temperature field data, and grouting pressure and speed data are consistent with the experiment data, accurate simulation of the grout diffusion form and capture of the grout diffusion path in the porous medium are implemented.
Step 7: After the grouting is completed, data display and further analysis is performed on the obtained pressure data and temperature field data, and the pressure data is further analyzed to obtain a ratio of a grouting blockage material and a grouting pressure range applicable to the porous medium under influences of the temperature effect and the water containing level.
Step 8: Demolding is performed on a stone body inside the model to take out the same, and overall three-dimensional scanning is performed. Slicing positions are pre-marked to slice the stone body, and grout diffusion path images of the stone body in all cross sections are further compared. If the section shows a full-permeation form of the grout, then time matching with a simulation result is performed through permeation time deduced by a permeation rate, if a result shows consistency, then it is assumed that a diffusion result of simulation of the segment is the grout diffusion form, and if there is an area which no grout permeates into in part of the section, there is a diffusion behavior of compacting the grout, which is shown as a cavity in the slice. Through a three-dimensional scanning technology, spatial point cloud data of a cavity form is obtained, and clustering analysis is performed on point cloud coordinates of a position of the cavity to implement extraction of discontinuous points and fitting. According to a marked position of the cavity in the slice, coordinate correspondence with a three-dimensional model of the stone body is performed to determine a compacting grouting position and scope, and a final diffusion form of a compacting grouting part is determined by comparison further in combination with the cavity form, a simulated form, and corresponding grout permeation time. If there is a crack in a section, three-dimensional scanning is performed on the crack and the corresponding slice, and clustering analysis is performed on point cloud coordinates at the crack to implement extraction of discontinuous points and fitting, and spatial coordinates of the crack located at the stone body are extracted to determine a diffusion form of splitting grouting. Through the above steps, accurate capture of multi-mode diffusion of the grout in a porous medium formation is implemented. Based on the acquired visual display, effective analysis is performed, according to the diffusion result and data, on influence factors of compacting grouting of the grouting of the porous medium, a splitting pressure boundary point and influence factors to acquire splitting pressure values, splitting and compacting consolidated body forms, splitting and compacting grouting rules, and the like under the action of different factors.

A person skilled in the art should understand that the modules or steps of the present invention may be implemented by using a general-purpose computer device. Optionally, the modules or steps may be implemented by using program code that can be executed by a computing device, so that the modules or steps may be stored in a storage device and executed by the computing device, or the modules or steps are separately manufactured into various integrated circuit modules, or multiple modules or steps in the modules or steps are manufactured into a single integrated circuit module for implementation. The present invention is not limited to any particular combination of hardware and software.

The specific implementations of the present invention are described above with reference to the drawings, but are not intended to limit the protection scope of the present invention. A person skilled in the art should understand that various modifications or variations may be made without creative efforts based on the technical solutions of the present invention, and such modifications or variations shall fall within the protection scope of the present invention.

1. A physical simulation system of porous medium grouting with temperature effect consideration, comprising: a porous medium formation simulation model, a grouting system, a water level regulation system, a formation temperature control system, a data collection system, and a data analysis system, wherein:
the porous medium formation simulation model comprises an experiment box, and the experiment box is filled with a porous medium;
the grouting system is in pipeline communication with a grout inlet of the porous medium formation simulation model to provide a grouting manner with controllable grouting rate and grouting pressure for the porous medium formation simulation model;
the water level regulation system is in pipeline communication with the porous medium formation simulation model to provide a water injection manner with an adjustable water supply amount and a controllable water temperature for the porous medium formation simulation model;
the formation temperature control system comprises a heating device and a temperature monitoring sensor, the temperature monitoring sensor is arranged in the porous medium formation simulation model, and the heating device is configured to heat an interior of the porous medium formation simulation model to simulate different ground temperatures;
the data collection system comprises a plurality of temperature sensors and pressure sensors, and the temperature sensors and the pressure sensors are respectively distributed at different positions in the porous medium formation simulation model; and
the data analysis system is in signal connection with the data collection system, and configured to perform verification and analysis on a grouting diffusion path by comparing data collected by the temperature sensor and the pressure sensor at different time series with temperature data and pressure data which are obtained through coupled solutions of a heat transfer equation and a Momentum Equation, specifically comprises:
constructing a fluid domain grid according to an experiment model, and setting initial boundary conditions, wherein the initial boundary conditions comprise a grouting speed, a grouting pressure, a grout temperature, and grout viscosity; and constructing the Momentum Equation according to the grouting speed, the grouting pressure, a phase fraction, and the grout viscosity, and predicting the grouting speed by solving momentum;
wherein, the Momentum Equation is:
$$\frac{\partial ( ρ v )}{\partial t} + ∇ \cdot ( ρ vv ) = - ∇ p + ∇ \cdot ( μ ∇ v ) + ρ g + {F}_{st} ,$$
wherein, ρ is density, p is a pressure, μ represents a viscosity function dependent on time t and the grout temperature T, which are obtained through experiments, g is a gravitational acceleration, and Fₛₜ is a surface tension;
the grouting speed is obtained by solving a discrete Momentum Equation:
$$\frac{{ρ}^{n + 1} {v}^{n + 1} - {ρ}^{n} {v}^{n}}{Δ t} \cdot {V}_{C V} + {\sum }_{faces} {( ρ v v )}^{n} \cdot {S}_{face} = - {\sum }_{faces} {p}^{n} {S}_{face} + {\sum }_{faces} {( μ ∇ v )}^{n} \cdot {S}_{face} + {ρ}^{n} g \cdot {V}_{C V} + {F}_{s t}^{n} \cdot {V}_{C V} ,$$
wherein, ρⁿ⁺¹vⁿ⁺¹ and ρⁿvⁿ are a product of the density and the speed at a new time step and an old time step, respectively, V_{CV} is a volume of a control volume, S_{face} is an area vector of a control volume face, pⁿ is a pressure at a current time step, (μΛv)ⁿ is a viscous stress at the current time step, g is the gravitational acceleration,
$${F}_{s t}^{n}$$
and Δt is a time step size;
a grout-water continuity equation is:
$$( ∇ \cdot v = 0 ) ,$$
wherein, v is a fluid speed vector,
a discrete continuity equation is coupled to the Momentum Equation to iteratively solve for the grout pressure and the grouting speed, and after a predetermined iteration count is reached, the grouting pressure and grouting speed are obtained as a grouting pressure and grouting speed v for the current time step,
according to the grouting speed v at the current time step, a grout-water heat transfer equation is constructed:
$$ρ {c}_{p} \frac{\partial T}{\partial t} + ρ {c}_{p} v \cdot ∇ T = ∇ \cdot ( k ∇ T ) + Q , \\ Q = - Δ {H}_{rxn} r ,$$
wherein, T is a temperature, cₚ is a specific heat capacity of a fluid, k is thermal conductivity of the porous medium, Q represents a quantity of heat generated and released in a phase change process in which grout is cured, ΔHᵣₓₙ is an empirical value for heat released per mole of a reaction, r is an empirical value for a rate of a chemical reaction, and v is the fluid speed vector;
the grout temperature is obtained by solving a discrete prediction equation:
$$\frac{ρ {c}_{p} ( {T}_{n e w} - {T}_{o l d} )}{Δ t} \cdot {V}_{C V} + {\sum }_{faces} ρ {c}_{p} vT \cdot {S}_{face} = {\sum }_{faces} k ∇ T \cdot {S}_{face} ,$$
wherein, T_{new} and T_{old} are a temperature at the new time step and the old time step, respectively, Δt is the time step size, V_{CV} is the volume of the control volume, S_{face} is the area vector of the control volume face, and a direction is perpendicular to the face and points to an outside;
a discrete heat transfer equation is coupled to the Momentum Equation to iteratively solve for the grout temperature the grouting speed, and after the predetermined iteration count is reached, the grout temperature and grouting speed v are obtained;
according to the grouting speed v at the current time step, a discrete grout-water two-phase phase fraction equation is constructed, a grout diffusion form in the porous medium is obtained by solving the phase fraction equation, and the grout-water two-phase phase fraction equation is:
$$( \frac{\partial α}{\partial t} + ∇ \cdot ( α v ) = 0 ) ,$$
wherein, α represents a proportion of a volume occupied by a particular phase in a specified volume;
according to repeated iteration of the above equation, finally, visual presentation of a grout diffusion path is implemented by the phase fraction equation; and
upon simulation, temperature field data and grouting pressure data at the current time step are compared with experiment-measured data, if the temperature field data, and grouting pressure and speed data are consistent with the experiment data, accurate simulation of the grout diffusion form and capture of the grout diffusion path in the porous medium are implemented.

2. The physical simulation system of porous medium grouting with temperature effect consideration according to claim 1, wherein a grout-permeable partition plate is arranged in the experiment box, a position in the experiment box and below the grout-permeable partition plate is filled with the porous medium, and a position in the experiment box and above the grout-permeable partition plate is filled with a cobblestone cushion layer.

3. The physical simulation system of porous medium grouting with temperature effect consideration according to claim 1, wherein the grouting system comprises a grout storing tank, a screw, a piston, and a gas pressure regulation valve, the grout storing tank is configured to store the grout, the screw is arranged on a screw platform and located in the grout storing tank, the piston is arranged below the screw, a gas pressure regulation channel is arranged between the screw platform and the piston, and the piston is provided with a gas pressure valve.

4. The physical simulation system of porous medium grouting with temperature effect consideration according to claim 1, wherein the water level regulation system comprises a water level sensor, a water tank, and a water level controller; the water level sensor is arranged in the experiment box, and the water tank is in pipeline communication with the porous medium formation simulation model; and the water level controller controls, according to a water level detected by the water level sensor in the experiment box, the water tank to start and stop water injection for the porous medium formation simulation model.

5. The physical simulation system of porous medium grouting with temperature effect consideration according to claim 1, wherein the data collection system further comprises earth pressure sensors and osmotic pressure sensors, and the earth pressure sensors are arranged around an inside of the experiment box and at a grout outlet, and configured to monitor a pressure change in a grouting process; and the osmotic pressure sensors are arranged inside the porous medium, and configured to monitor a pressure of pore water inside the porous medium.

6. The physical simulation system of porous medium grouting with temperature effect consideration according to claim 5, wherein the data analysis system is further configured to perform analysis according to pressure data, monitored by the earth pressure sensor, in the grouting process to obtain a pressure range applicable to grouting blockage of the porous medium under influences of the temperature effect and a water containing level; and the heating device uses an external circulating water bath temperature control manner, and is configured to provide a constant-temperature environment required for a porous model.

7. The physical simulation system of porous medium grouting with temperature effect consideration according to claim 1, further comprising a waste liquid treatment system, wherein the waste liquid treatment system is in pipeline communication with the porous medium formation simulation model, and configured to perform grout-water solid-liquid separation on a waste liquid flowing out of the porous medium formation simulation model.

8. An experimental method of porous medium grouting with temperature effect consideration, comprising:
injecting water with a preset water containing level and a preset water temperature to a porous medium formation simulation model by a water level regulation system, wherein the porous medium formation simulation model is filled with a porous medium;
heating an interior of the porous medium formation simulation model to a preset ground temperature by a formation temperature control system;
performing, by a grouting system, grouting to the porous medium formation simulation model from a grout inlet formed below the porous medium formation simulation model;
collecting, by a data collection system, temperature data and pressure data in a grouting process, and transmitting the same to a data analysis system;
performing, by the data analysis system, verification and analysis on a grouting diffusion path by comparing the temperature data and the pressure data which are collected by temperature sensors and pressure sensors at different time series with temperature data and pressure data which are obtained through coupled solutions of a heat transfer equation and a Momentum Equation, specifically comprises:
constructing a fluid domain grid according to an experiment model, and setting initial boundary conditions, wherein the initial boundary conditions comprise a grouting speed, a grouting pressure, a grout temperature, and grout viscosity; and constructing a Momentum Equation according to the grouting speed, the grouting pressure, a phase fraction, and the grout viscosity, and predicting the grouting speed by solving momentum;
wherein the Momentum Equation is:
$$\frac{\partial ( ρ v )}{\partial t} + ∇ \cdot ( ρ vv ) = - ∇ p + ∇ \cdot ( μ ∇ v ) + ρ g + {F}_{st} ,$$
wherein, ρ is density, p is a pressure, μ represents a viscosity function dependent on time t and the grout temperature T, which are obtained through experiments, g is a gravitational acceleration, and Fₛₜ is a surface tension;
the grouting speed is obtained by solving a discrete Momentum Equation:
$$\frac{{ρ}^{n + 1} {v}^{n + 1} - {ρ}^{n} {v}^{n}}{Δ t} \cdot {V}_{C V} + {\sum }_{faces} {( ρ v v )}^{n} \cdot {S}_{face} = - {\sum }_{faces} {p}^{n} {S}_{face} + {\sum }_{faces} {( μ ∇ v )}^{n} \cdot {S}_{face} + {ρ}^{n} g \cdot {V}_{C V} + {F}_{s t}^{n} \cdot {V}_{C V} ,$$
wherein, ρⁿ⁺¹vⁿ⁺¹ and ρⁿvⁿ are a product of the density and the speed at a new time step and an old time step, respectively, V_{CV} is a volume of a control volume, S_{face} is an area vector of a control volume face, pⁿ is a pressure at a current time step, (μΛv)ⁿ is a viscous stress at the current time step, g is the gravitational acceleration,
$${F}_{s t}^{n}$$
if the surface tension, and Δt is a time step size;
a grout-water continuity equation is:
$$( ∇ \cdot v = 0 ) ,$$
wherein, v is a fluid speed vector,
a discrete continuity equation is coupled to the Momentum Equation to iteratively solve for the grout pressure and the grouting speed, and after a predetermined iteration count is reached, the grouting pressure and grouting speed are obtained as a grouting pressure and grouting speed v for the current time step,
according to the grouting speed v at the current time step, a grout-water heat transfer equation is constructed:
$$ρ {c}_{p} \frac{\partial T}{\partial t} + ρ {c}_{p} v \cdot ∇ T = ∇ \cdot ( k ∇ T ) + Q , \\ Q = - Δ {H}_{rxn} r ,$$
wherein, T is a temperature, cₚ is a specific heat capacity of a fluid, k is thermal conductivity of the porous medium, Q represents a quantity of heat generated and released in a phase change process in which grout is cured, ΔHᵣₓₙ is an empirical value for heat released per mole of a reaction, r is an empirical value for a rate of a chemical reaction, and v is the fluid speed vector;
the grout temperature is obtained by solving a discrete prediction equation:
$$\frac{ρ {c}_{p} ( {T}_{n e w} - {T}_{o l d} )}{Δ t} \cdot {V}_{C V} + {\sum }_{faces} ρ {c}_{p} vT \cdot {S}_{face} = {\sum }_{faces} k ∇ T \cdot {S}_{face} ,$$
wherein, T_{new} and T_{old} are a temperature at the new time step and the old time step, respectively, Δt is the time step size, V_{CV} is the volume of the control volume, S_{face} is the area vector of the control volume face, and a direction is perpendicular to the face and points to an outside;
a discrete heat transfer equation is coupled to the Momentum Equation to iteratively solve for the grout temperature the grouting speed, and after the predetermined iteration count is reached, the grout temperature and grouting speed v are obtained;
according to the grouting speed v at the current time step, a discrete grout-water two-phase phase fraction equation is constructed, a grout diffusion form in the porous medium is obtained by solving the phase fraction equation, and the grout-water two-phase phase fraction equation is:
$$( \frac{\partial α}{\partial t} + ∇ \cdot ( α v ) = 0 ) ,$$
wherein, α represents a proportion of a volume occupied by a particular phase in a specified volume;
according to repeated iteration of the above equation, finally, visual presentation of a grout diffusion path is implemented by the phase fraction equation; and
upon simulation, temperature field data and grouting pressure data at the current time step are compared with experiment-measured data, if the temperature field data, and grouting pressure and speed data are consistent with the experiment data, accurate simulation of the grout diffusion form and capture of the grout diffusion path in the porous medium are implemented.

9. The experimental method of porous medium grouting with temperature effect consideration according to claim 8, wherein obtaining the temperature, the grouting speed, and the grout diffusion path through coupled solutions of the heat transfer equation and the Momentum Equation is specifically:
constructing the fluid domain grid according to the porous medium grouting experiment model, and performing initialization;
constructing the Momentum Equation according to the grouting speed, the grouting pressure, the phase fraction, and the grout viscosity, and predicting the grouting speed at the current time step according to the Momentum Equation;
establishing a grout-water heat transfer prediction equation according to the predicted grouting speed at the current time step, and predicting the grout temperature and the grouting speed at the current time step according to the grout-water heat transfer prediction equation; and
constructing the grout-water two-phase phase fraction equation according to the grouting speed at the current time step, and performing iterative calculation until the predetermined iteration count is reached to implement analysis of the grout diffusion path.

10. The experimental method of porous medium grouting with temperature effect consideration according to claim 9, further comprising: comparing the obtained temperature data and pressure data at the current time step with the measured temperature data and pressure data, and determining accuracy of the grout diffusion simulation according to a comparison result; and obtaining a stone body inside a simulation experiment, analyzing a grout diffusion path image of a slice of the stone body, and verifying and capturing the grout diffusion form according to a representation form of grout permeation of the grout diffusion path image, a cavity, and a crack form.
